(19) United States
(12) Patent Application Publication
(10) Pub. No.: US 2025/0069169 A1
(43) Pub. Date: Feb. 27, 2025

(54) Automated Discovery Of Real Estate Parcels Using Geographic Information System Data Sources

(71) Applicant: ProforMap, Inc., Walnut Creek, CA (US)

(72) Inventor: Iman Novin, Walnut Creek, CA (US)

(21) Appl. No.: 18/727,841

(22) PCT Filed: Jan. 11, 2023
(86) PCT No.: PCT/US2023/000002

§ 371 Date: Jul. 10, 2024

Related U.S. Application Data
(60) Provisional application No. 63/298,356, filed on Jan. 11, 2022.

(51) Int. Cl. G06Q 50/16; G06F 16/2457; G06F 16/9537; G06F 16/9538

(52) U.S. Cl. CPC G06Q 50/165; G06F 16/24578; G06F 16/9537; G06F 16/9538

(57) ABSTRACT

A method includes outputting data for displaying a first portion of a user interface, the first portion of the user interface includes a first sub-portion for receiving selection data for selecting layers of geographical information system data from at least two geographical information service data sources of the multiple geographic information system data sources and a second sub-portion for receiving search criteria, wherein at least one search criteria of the search criteria is related to the at least two geographical information system data; transmitting search criteria to a subset of the geographical information system data sources corresponding to the selection data; receiving parcel data from the subset of the geographical information system data sources identifying properties satisfying the search criteria; and outputting data for displaying a second portion of the user interface, wherein the second portion of the user interface includes an identification of properties that satisfy the search criteria.

### CROSS-REFERENCE TO RELATED APPLICATION(S)

This application is a United States National Phase filing under 35 U.S.C. § 371 of PCT Application PCT/US2023/000002 filed Jan. 11, 2023, published as WO2023/136969, which claims priority to and benefit of U.S. Provisional Patent Application Ser. No. 63/298,356, filed Jan. 11, 2022, the entire disclosures of which are incorporated herein by reference in their entireties.

### TECHNICAL FIELD

This disclosure relates to a system and method for automated discovery of parcels using geographic information system (GIS) data sources.

### BACKGROUND

Developers typically spend significant resources identifying potential real estate parcels for a development project. The developer may plan a real estate development project and determine the criteria of a parcel suitable for the development project. The developer may then attempt to find a suitable parcel for the development from current listings based on the criteria. The criteria can include numerous criteria such as the size of the parcel, the characteristics of the neighborhood surrounding the parcel, zoning ordinances for the parcel, transportation features related to the parcel, and other related criteria. The developer may interact with a broker to find a parcel from among the property listings that meets the needs of their development project. In some instances, the developer may not find a suitable parcel that satisfies all of the criteria, and the developer may either select a less than ideal parcel or modify their development project to account for the available parcels. In other instances, a broker may have an existing parcel that they are trying to sell, and the broker may spend significant resources trying to find a developer to develop the existing parcel. In each of these situations, matching a parcel with a developer may be resource intensive since in addition to finding a suitable parcel, the developer may need to determine the feasibility of the development project at the parcel since the value of the development may be dependent on the selected parcel site. The developer may not know the potential return on investment of their development project until a site is selected, but the determination of the optimal development project may be dependent on the available parcels. In some instances, a developer may find multiple parcels that may be suitable for the project and the developer may need to determine the feasibility of the development at each site to determine the best parcel to develop.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram showing an example of a system for automated discovery of real properties using GIS data sources.

FIG. 2 is a block diagram of an example of a computing device which may be used to implement portions of the system for automated discovery of real properties using GIS data sources.

FIG. 3 is a block diagram showing an example of software tools of a system for automated discovery of real properties using GIS data sources.

FIG. 4 is a block diagram of examples of a process flow of a system for automated discovery of real properties using GIS data sources.

FIGS. 5 through 11 are examples of portions of a graphical user interface (GUI) of a system for automated discovery of real properties using GIS data sources.

FIGS. 12 through 15 are block diagrams of examples of techniques for automated discovery of real properties using GIS data sources.

### DETAILED DESCRIPTION

Developers typically begin a development project by creating a rough design of a project and then attempt to find a suitable parcel for the design. The rough design may be based on different factors such as the developers past experience, the amount of funding the developer has access to, and the current state of the market. For instance, a developer that has had past success with low-income housing projects may plan low-income housing for their next project. Or a developer that develops commercial properties will likely continue to develop commercial properties. The amount of funding a developer has access can drive the overall size of the development. The developer will also pay attention to market conditions in planning their project. For instance, if there is a lack of high-end housing, the developer may plan high end housing. Or, if a government program incentivizes multi-family housing, the developer may take advantage of the government program and development multi-family housing.

Finding available properties suitable for the development can require a developer to review available property listing to find potential candidates and then review information about the properties such as city development plans, zoning maps, building codes, transportation maps, and other data for each parcel to find a suitable match. Additionally, a value analysis of each suitable parcel may be performed to determine the feasibility of the development at that particular parcel. As part of the feasibility, the developer may need to perform a more detailed, preliminary design for the site to study site specific issues. This process can take several months and cost tens of thousands of dollars for each parcel. At the same time, the developer needs to move quickly since the pool of available properties may be limited and other developers may be pursuing the same properties.

Implementations of this disclosure address issues such as these by automating the discovery of parcels using GIS data sources. In place of relying on property listings to find suitable properties, the discovery of parcels using GIS data sources performs in a manner that is not only faster than a conventional property search but is able to account for more detail about the parcel and can assist in the selection of an optimal parcel and configuration for a development project. Additionally, by leveraging the GIS data sources, the automated discovery of parcels using GIS data sources allows a developer to find parcels that may not be currently listed or otherwise hidden in a conventional search by a developer.

A system implementing automated discovery of parcels using GIS data sources can discover suitable parcels for a development by receiving selection data that defines requirements for a suitable parcel, transmits the search criteria to multiple GIS data sources, receives parcel datasets from the GIS data sources responsive to the search criteria, fuses the parcel datasets to produce a group of candidate parcels. In some implementations, the system can perform a value analysis of the candidate sites to identify an optimal site for development. In some implementations, the system can recommend potential parcels that are not currently listed for sale, determine an optimized development plan for each potential parcel based on a developer's criteria, recommend a developer based on an identification of a parcel, or combinations thereof. In some implementations, the system can facilitate communication between the developer and owners/agents of a selected parcel, provides a platform for closing a transaction for a parcel, or may perform combinations thereof.

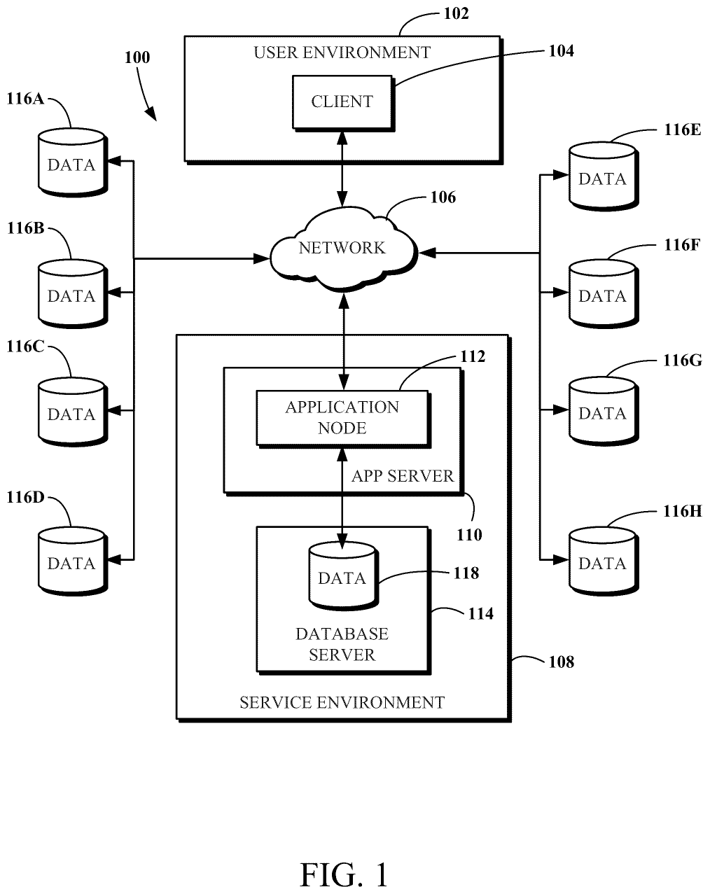

Reference is first made to examples of hardware and software structures used to implement a system for automated discovery of parcels using GIS data sources. FIG. 1 is a block diagram showing an example system 100 for automated discovery of parcels using GIS data sources. The system 100 for automated discovery of parcels using GIS data sources can be or include a distributed computing system (e.g., a client-server computing system), a cloud computing system, a clustered computing system, or the like.

The system 100 includes a user environment 102, which may be or otherwise refer to devices, configurations, objects, or the like under the possession, control, or use by a public entity, private entity, or other corporate entity or individual that purchases or otherwise uses software services. The user environment 102 includes one or more clients. For example, and without limitation, the user environment 102 can include client 104. The client 104 can include one or more computing devices, such as a mobile phone, a tablet computer, a laptop computer, a notebook computer, a desktop computer, or another suitable computing device or combination of computing devices.

In some implementations, the client 104 can be implemented as a single physical unit or as a combination of physical units. In some implementations, a single physical unit can include multiple clients. In some implementations, the client 104 can be an instance of software running on a device associated with the user environment 102. As used herein, the term “software” can include, but is not limited to, applications, programs, instances, processes, threads, services, plugins, patches, application version upgrades, or other identifiable computing aspects.

A network 106 connects the user environment 102 and a service environment 108.

The service environment 108 can include one or more servers used to implement software, such as Platform-as-a-Service (PaaS) software, Soft-ware-as-a-Service (SaaS) software, software specific to mobile devices, web application software, or other software. For example, and without limitation, the service environment 108, as generally illustrated, includes an application server 110 which implements an application node 112 and a database server 114 which implements a database 118.

In some implementations, the servers in the service environment 108 may be located at a datacenter. A datacenter can represent a geographic location, which can include a facility, where the one or more servers are located. The system 100 can include a number of datacenters and servers, or it can include a configuration of datacenters and servers different from that generally illustrated in FIG. 1. In some implementations, the service environment 108 can be associated or communicate with one or more datacenter networks or domains, which can include domains other than a client domain, such as which can be associated with the client 104.

The client 104 and the servers associated with the service environment 108 may be configured to connect to, or communicate via, the network 106. Furthermore, the client 104 associated with the user environment 102 can connect to the network 106 via a communal connection point, link, or path or using a distinct connection point, link, or path. A connection point, link, or path can be wired, wireless, use other communications technologies, or a combination thereof.

The network 106 can be or include the Internet. Alternatively, the network 106 can be or include a local area network (LAN), a wide area network (WAN), a virtual private network (VPN), or another public or private means of electronic computer communication capable of transferring data between a client, such as the client 104, and one or more servers associated with the service environment 108, or a combination thereof. The network 106, the service environment 108, or any other element, or combination of elements, of the system 100 can include network hardware such as routers, switches, load balancers, other network devices, or combinations thereof.

In the example shown and as described above, the service environment 108 includes the application server 110 and the database server 114. The application server 110 and/or the database server 114 can be a computing system, which can include one or more computing devices, such as a desktop computer, a server computer, or any other computer capable of operating as a server. In some implementations, the application server 110 and/or the database server 114 can be nonhardware servers implemented on a physical device, such as a hardware server. In some implementations, the application server 110 and the database server 114 can be implemented as a single hardware server or as a single nonhardware server implemented on a single hardware server. In some implementations, the service environment 108 can include servers other than or in addition to the application server 110 or the database server 114, for example, a web server.

The application node 112 is or otherwise refers to a process executed on the application server 110. For example, and without limitation, the application node 112 can be executed in order to deliver services to a client, such as the client 104, as part of a web application, either as standalone software or as an online component to other software. The application node 112 can be implemented using processing threads, virtual machine instantiations, or other computing features of the application server 110. In some implementations, the application node 112 can store, evaluate, or retrieve data from a database, such as the database 118 of the database server 114.

The application server 110 can include a number of application nodes, depending upon a system load or other characteristics associated with the application server 110. For example, and without limitation, the application server 110 can include two or more nodes forming a node cluster. The application nodes implemented on a single application server 110 may run on different hardware servers.

The database server 114 can be configured to store, manage, or otherwise provide data for delivering services to the client 104 over a network. The database server 114 may include a data storage unit, such as the database 118, which can be accessible by an application executed on the application node 112. The database 118 may be implemented as a relational database, an object database, an extensible markup language (XML) database, a configuration management database (CMDB), a management information base (MIB), one or more flat files, other suitable non-transient storage mechanisms, or a combination thereof. While limited examples are described, the database 118 can be configured as or comprise another suitable database type. Further, the system 100 can include one, two, three, or another number of databases configured as or comprising another database type or combination thereof.

In some implementations, one or more databases (e.g., the database 118), tables, other information sources, or portions or combinations thereof may be stored, managed, or otherwise provided by one or more of the elements of the system 100 other than the database server 114, such as the client 104 or the application server 110.

Some or all of the systems and techniques disclosed herein can operate or be executed on or by the servers associated with the system 100. In some implementations, the systems and techniques disclosed, portions thereof, or combinations thereof can be implemented on a single device, such as a single server, or a combination of devices, for example, a combination of the client 104 and a server which implements the application server 110 and/or the database server 114.

In some implementations, the system 100 can include devices other than the client 104, and a server which implements the application server 110 and/or the database server 114. In some implementations, one or more additional servers can operate as system infrastructure control aspects, from which servers, clients, or both servers and clients, can be monitored, controlled, configured, or a combination thereof.

The service environment 108 allocates resources of the user environment 102 using a single-tenant architecture or a multi-tenant architecture. Allocating resources in a multi-tenant architecture can include installations or instantiations of one or more servers, such as application servers, database servers, or another server or a combination of servers, which can be shared amongst multiple user environments or multiple accounts within a single user environment. For example, a web server, such as a unitary Apache installation; an application server, such as a unitary Java Virtual Machine (JVM); or a single database server catalog, such as a unitary MySQL catalog, can handle requests from multiple user environments or multiple accounts within a single user environment. In some implementations of a multi-tenant architecture, the application server, the database server, or both can distinguish between and segregate data or other information of the various users of the system. In a single-tenant infrastructure, separate web servers, application servers, database servers, or combinations thereof can be provisioned individually for at least some user environments or accounts within a user environment. User environments or accounts within a user environment can access one or more dedicated web servers, have transactions processed using one or more dedicated application servers, or have data stored in one or more dedicated database servers, catalogs, or both. Physical hardware servers can be shared such that multiple installations or instantiations of web servers, application servers, database servers, or combinations thereof can be installed on the same physical server. An installation can be allocated a portion of the physical server resources, such as memory, storage, communications bandwidth, or processor cycles.

A user environment instance can include multiple web server instances, multiple application server instances, multiple database server instances, or a combination thereof. The server instances can be physically located on different physical servers and can share resources of the different physical servers with other server instances associated with other customer instances. In a distributed computing system, multiple user environment instances can be used concurrently. Other configurations or implementations of user environment instances can also be used. The use of user environment instances in a single-tenant architecture can provide true data isolation from other her user environment instances, amongst other benefits.

The system 100 is connected to multiple GIS data sources 116A-116H (collectively references as GIS data sources 116) that each store GIS data. The GIS data sources may be publicly accessible or may require a subscription or payment to access. Each GIS data source may be associated with an entity and be independent of the other GIS data sources and their related entities. For instance, a first GIS data source may be provided as a public service by a city, a second GIS data source may be privately owned and require payment for access, and a third GIS data source may be state owned and provided as a public service. Each GIS data source may be connected to the network 106 and provide an application programming interface (API) for accessing the data contained in the GIS data source. The APIs for the GIS data sources may share a common format, or, in some instances, at least one API may be different than another API. In some instances, at least one GIS data source may store information as objects in an object-relational database system such as PostgreSQL using PostGIS extensions. The service environment includes an application for accessing the GIS data sources by generating a data query, transmitting the data query to a GIS data source, and obtaining GIS datasets from the GIS data source in response to the data query. The application can generate different formats of data queries for interacting with the different GIS data sources.

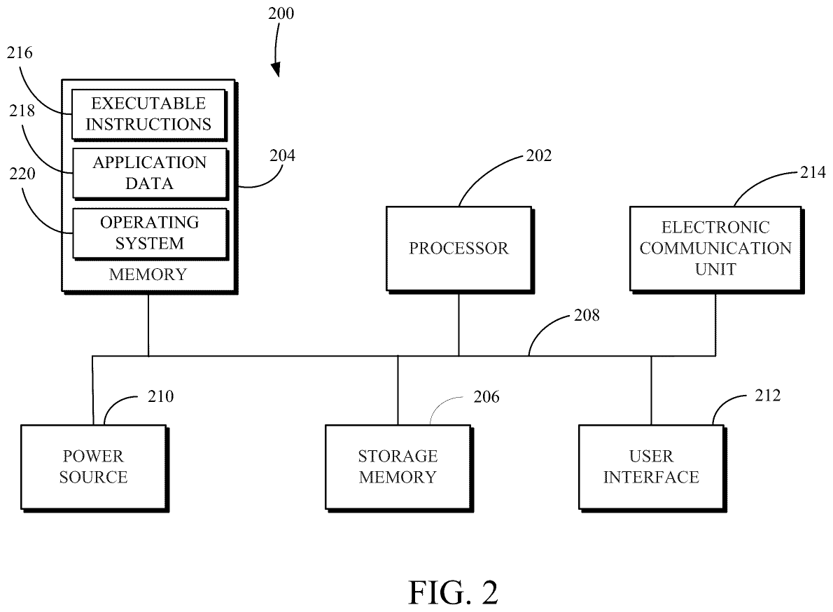

FIG. 2 is a block diagram of a computing device 200 which may be used to implement portions of a system for automated discovery of parcels using GIS data sources. For example, the computing device 200 may be used to implement a server which implements some or all of a service environment (e.g., the service environment 108 shown in FIG. 1). Alternatively, the computing device 200 may be used to implement a client that accesses the server (e.g., the client 104 shown in FIG. 1). As a further alternative, the computing device 200 may be used as or to implement another client, server, or other device according to the implementations disclosed herein.

The computing device 200 includes components or units, such as a processor 202, a memory 204, a storage memory 206, a bus 208, a power source 210, a user interface 212, and an electronic communication interface 214. One of more of the memory 204, storage memory 206, the power source 210, the user interface 212, or the electronic communication interface 214 can communicate with the processor 202 via the bus 208.

The processor 202 is a central processing unit, such as a microprocessor, and can include single or multiple processors having single or multiple processing cores. Alternatively, the processor 202 can include another type of device, or multiple devices, now existing or hereafter developed, configured for manipulating or processing information. For example, the processor 202 can include multiple processors interconnected in any manner, including hard wired or networked, including wirelessly networked. For example, the operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory of the memory 204 can be random access memory (RAM) (e.g., a dynamic random-access memory (DRAM) module, such as double data rate (DDR) synchronous dynamic random-access memory (SDRAM)) or another form of volatile memory. The memory 204 may also include other types of devices, now existing or hereafter developed, configured for storing data or instructions for processing by the processor 202. The memory 204 can include data for immediate access by the processor 202. For example, the memory 204 can include executable instructions 216, application data 218, and an operating system 220. The executable instructions 216 can include one or more application programs, which can be loaded or copied, in whole or in part, from storage memory 206 to memory 204 to be executed by the processor 202. For example, the executable instructions 216 can include instructions for performing some or all of the techniques of this disclosure. The application data 218 can include user data, database data (e.g., database catalogs or dictionaries), or the like. The operating system 220 can be, for example, Microsoft Windows®, Mac OS X®, or Linux®; an operating system for a small device, such as a smartphone or tablet device; or an operating system for a large device, such as a mainframe computer.

The storage memory 206 can be non-volatile memory such as a disk drive, a solid-state drive, flash memory, phase-change memory, or another form of non-volatile memory configured for persistent electronic information storage.

The power source 210 includes a source for providing power to the computing device 200. For example, the power source 210 can be an interface to an external power distribution system. In another example, the power source 210 can be a battery, such as where the computing device 200 is a mobile device or is otherwise configured to operate independently of an external power distribution system.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The electronic communication interface 214 provides a communication connection or link to other computing devices. For instance, the electronic communication interface 214 can be a network adaptor operable to connect to a network (e.g., the network 106 shown in FIG. 1). The electronic communication interface 214 can be a wired network interface or a wireless network interface. The computing device 200 can communicate with other devices via the electronic communication interface 214 using one or more communication protocols, such as using Ethernet, transmission control protocol (TCP), internet protocol (IP), power line communication, Wi-Fi, Bluetooth, infrared, general packet radio service (GPRS), global system for mobile (GSM), code division multiple access (CDMA), Z-Wave, ZigBee, another protocol, or a combination thereof.

Implementations of the computing device 200 may differ from what is shown and described with respect to FIG. 2. In some implementations, the memory 204 can be distributed across multiple devices. For example, the memory 204 can include network-based memory or memory in multiple clients or servers performing the operations of those multiple devices. In some implementations, the application data 218 can include functional programs, such as a web browser, a web server, a database server, another program, or a combination thereof.

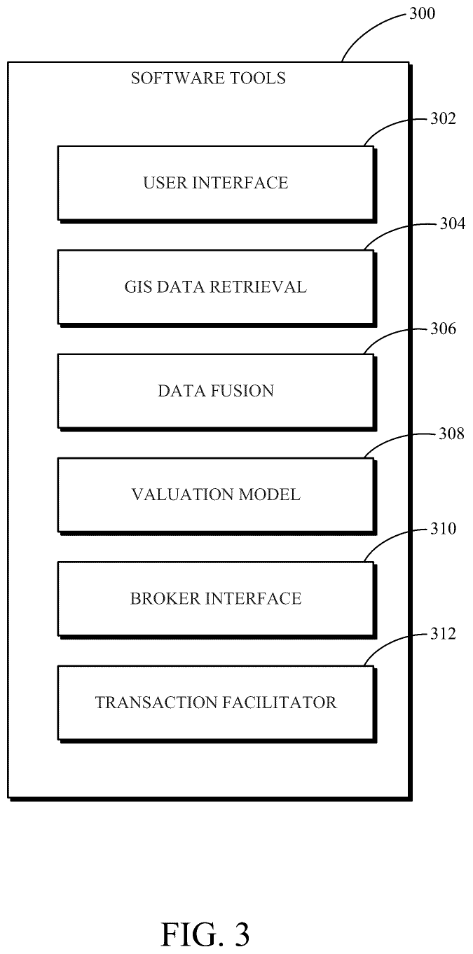

FIG. 3 is a block diagram showing an example of software tools 300 of a system for automated discovery of properties using GIS data sources, such as the system 100 shown in FIG. 1. In the example as generally shown, the software tools 300 includes a user interface software tool 302, a GIS data retrieval tool 304, a GIS data fusion tool 306, a valuation model tool 308, a broker interface tool 310, and a transaction facilitator tool 312.

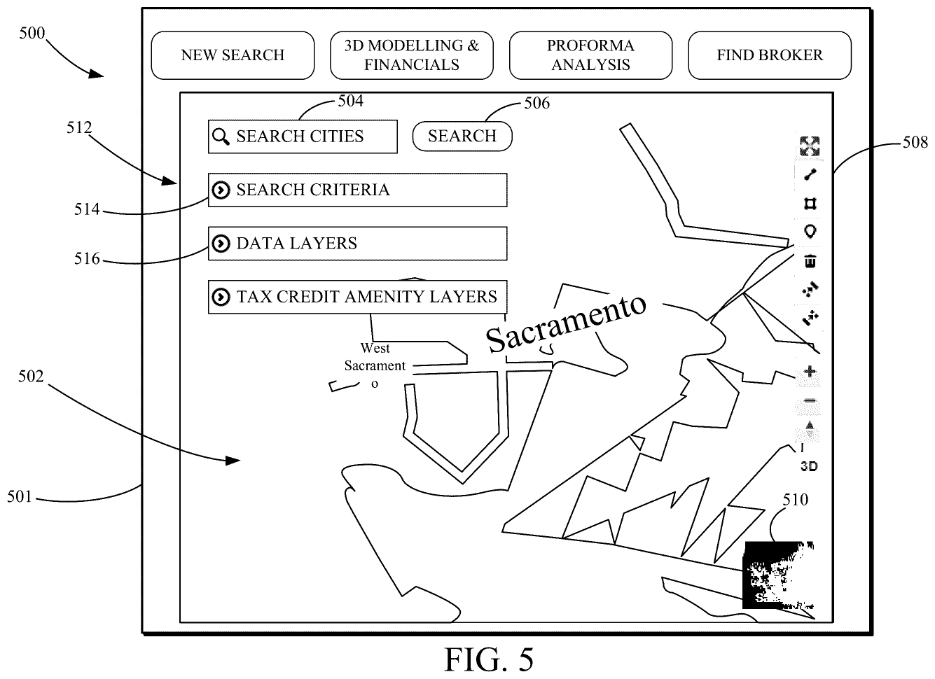

The user interface software tool 302 is a software tool which generates data for displaying elements of a GUI at a client, such as the client 104 of FIG. 1, and receives user input data from the GUI. The user interface software tool 302 transmits data for displaying user interface (UI) elements of the GUI and receives user input data by way of a network, such as the network 106 of FIG. 1. Examples of a GUI that may be displayed at a client are shown with reference to FIGS. 5-11.

The UI elements displayed at the GUI can include text information fields for displaying text information, graphical elements for displaying graphical information, and other UI elements. The UI elements can also receive user input data including a selection by a user of a UI element, an input of text data in a text box, and other user inputs. The displayed UI elements can be dependent on a user input, such that the GUI is dynamically updated responsive to a user selecting a particular UI element.

The GIS data retrieval tool 304 is a software tool which interfaces with GIS data sources, such as the GIS data sources 116 of FIG. 1, to retrieve GIS datasets. The GIS data retrieval tool 304 may communicate with the GIS data sources by way of a network, such as the network 106 of FIG. 1. In some implementations, the GIS data retrieval tool 304 may pre-load GIS datasets, cache GIS datasets, or store GIS datasets locally.

The GIS data retrieval tool 304 may receive user input data from the user interface software tool 302 and generate a query or command for communicating with a GIS data source based on the user input data. The query or command is dependent on the GIS data source and a communication interface provided by the GIS data source. In some instances, a GIS data source may provide an API for interacting with the GIS data source. In such instances the GIS data retrieval tool 304 may communicate with the GIS data source using the API.

The GIS data fusion tool 306 is a software tool which fuses the GIS datasets from multiple GIS data sources. Each dataset retrieved from a GIS data source includes parcels matching criteria for that particular GIS data source. Because the GIS data sources do not contain the same information, each dataset returned from the GIS data sources can contain parcels that are not suitable based on the criteria sent to other GIS data sources. The process of fusing the datasets can remove parcels that do not meet all of the search criteria. In some instances, the GIS data fusion tool 306 fuses the dataset by performing an intersection operation of the datasets to identify the properties that are common in each of the datasets. In other instances, the GIS data fusion tool 306 fuses the datasets by performing a union operation and keeping all of the parcels in the datasets. In such instances, the GIS data fusion tool 306 may rank the parcels based on a criterion such as the number of datasets a parcel appears in. In some instances, the GIS data fusion tool 306 may perform an intersection operation for a portion of the datasets and a union operation for the remaining datasets. The GIS data fusion tool 306 may determine to perform a union or an intersection based on a user preference.

The valuation model tool 308 is a software tool which projects value information about a development project based on a selected parcel. The valuation model tool can project such information as total development cost, a market value, a return on investment, ideal unit mix, and pro forma data. The valuation model may base its projects based on models using historical development project criteria, past predicted valuations, and current market values as training data. In some implementations, the valuation models may be a machine learning model trained using historical development project criteria, historical predicated valuations, and current market values. In some instances, the machine learning model may be unsupervised and may predict patterns of information driving the valuations. In other instances, the machine learning model may be supervised and used to predict valuations. In implementations using a machine learning model, the machine learning model may be retrained to incorporate closed transactions of development projects that were previously used for predictions.

The broker interface tool 310 is a software tool which facilitates communication with a broker or other entity representing a parcel. The broker interface tool may provide a developer with contact information of the broker or, in some instances, may provide a broker with contact information of the developer interested in a parcel. In some instances, the broker interface tool 310 may implement a communication platform such as a chat, email, message board, or other communication tool for secure communications between the developer and the broker.

The transaction facilitator tool 312 is a software tool which facilitates brokering a transaction for the parcel. For instance, the transaction facilitator tool may include an interface for tracking contacts between parcel owners, brokers, and developers, assign brokers to parcels of interest, automate escrow for closing a sale, provide secure document storage for sharing documents between a developer and a parcel owner, and provide services for authenticating documents, provide signature services, and acquire title documents related to the parcel.

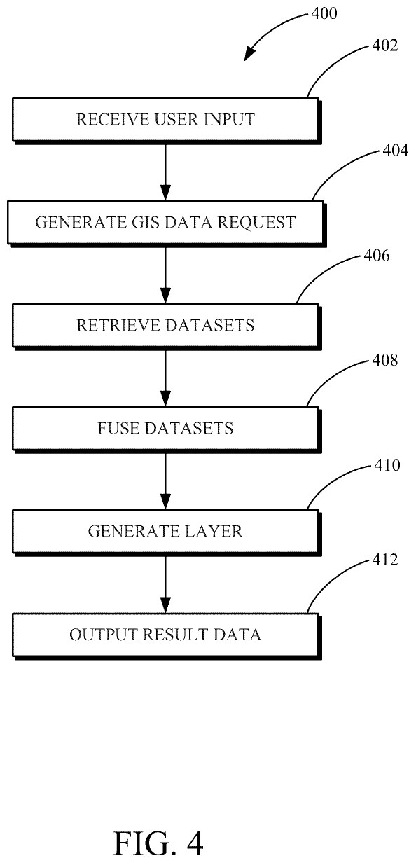

FIG. 4 is a block diagram of examples of a process flow of a system for automated discovery of parcels using GIS data sources. Portions of the process can be implemented by a computing device such as the computing device 200 shown in FIG. 2. Instructions for implementing portions of the process by the computing device may be stored in memory and executed by a processor to implement the process flow. In some instances, different portions of the process flow may be implemented using different computing devices.

At 402, a user input is received. For instance, a user may interact with a client, such as client 104 of FIG. 1, to input parcel search criteria. The parcel search criteria can include a city, physical parcel requirements, and GIS data requirements.

In some implementations, the user input may be received in stages. For instance, the user may first type in a city before selecting other requirements. Once a city is selected, the GUI may zoom in on the city and then present user interface elements for receiving other criteria, such as physical parcel requirements and related GIS requirements. In some instances, not all of the GIS sources are available for every city. By receiving the selection of a city before presenting the user interface elements for receiving GIS requirements, the system can filter available GIS options to present only those options to the user that are actually available. For example, if the city selected by the user did not have a GIS layer for flood zones, an option to include a flood zone parameter in the search criteria would not be displayed. When the user inputs a different city that does have a flood zone GIS layer, the system would then present a UI element for selecting flood zone criteria. In some instances, in place of restricting the display of unavailable GIS information, the system can include information identifying that the GIS information is not available for the city.

At 404, the system generates GIS data requests based on the user input. Each GIS data source may require different formats of data requests to retrieve datasets of parcels matching the search criteria. In some implementations, the system may general a standard data request using PostGIS or other database query language.

At 406, the system retrieves datasets that match the search criteria input by the user. The system may transmit the GIS data requests generated at 404 to GIS data sources, such as the GIS data sources 116 of FIG. 1. The GIS data sources may process the data queries and return datasets of geospatial objects corresponding to parcels that match the search criteria. The geospatial objects may contain geometric data corresponding to the outline of the parcel and information fields containing GIS information about the parcel.

At 408, the system fuses the datasets to include parcels that are relevant to the search criteria. For instance, the GIS data sources can each contain different GIS information and a parcel that matches the search criteria at a first GIS data source may not match the search criteria retrieved from a second data source. The system may fuse the dataset by creating an intersection of parcels in the retrieved datasets. For instance, for a parcel to appear in the fused dataset it would need to be present in each dataset retrieved from the GIS data sources.

In other implementations, the system can fuse the datasets using other techniques. For instance, the user interface may include a selection toggle indicating whether a search criterion is a hard criterion or a soft criterion. In such implementations, the system will create an intersection of the GIS datasets having the hard criteria and create a union of the GIS datasets having the soft criteria.

In still other implementations, the system may rank parcels based on how well they fit the selection criteria. For example, a parcel that matches all of the search criteria would be ranked higher than a parcel that is only a partial match with the selection criteria. In such implementations, the user interface may include a weight selection for each selection criteria allowing a user to assign a weight to each criterion. The system can then use the weight in determining the ranking of the parcels.

At 410, the system generates a map layer that includes the parcels identified in the fused dataset, GIS information for the parcels, and mapping information for locating the parcels. For example, the system may add information for displaying icons at geographic coordinates of each parcel in the fused dataset.

At 412, the system outputs the results data. For instance, the systems may output information for displaying a portion of a GUI to a client, such as client 104 of FIG. 1, that includes the results data. The results data may be presented as icons on a map corresponding to the location of a parcel on the map and/or as a table of results. The table of results may display in a ranked order based on a user preference.

FIGS. 5 through 11 are examples of portions of a GUI for a client of a system for automated discovery of parcels using multiple GIS data sources. FIG. 5 is an example of a portion of a GUI 500 illustrating a landing page 501 for a client of a system for automated discovery of parcels using GIS data sources. The landing page 501 can include a map portion 502 and a search criteria input 504. Information for displaying the landing page 501 may be generated by a user interface software tool such as the user interface software tool 302 of FIG. 3. For instance, a user interface software tool may generate information for displaying the portion of the GUI 500 and transmit the information to the client, which can display the portion of the GUI 500 at a display device. For instance, the portion of the GUI 500 may be displayed as portion of a html web page, or the portion of the GUI 500 may be displayed as a window in a dedicated client application.

The map portion 502 displays a map that a user may use to search for a parcel. The search criteria input 504 is configured to receive an input from the user for selecting a city to search. For instance, a user may input a name of a city to search and select a search button 506. The client then transmits data representing the name of the city to an automated parcel discovery system. The client may zoom the map portion 502 to the selected city in response to receiving the user input. In some implementations, the client may zoom the map portion 502 to the selected city responsive to receiving updated information from the user interface software tool for updating the map portion 502 of the GUI.

The GUI may include other GUI elements for navigating a map, such as navigation controls 508 and a satellite view 510. In some instances, the client may send information to the automated parcel discovery system for selecting cities currently viewable in the map portion 502 in place of sending a received text input selecting a city. For example, the client may send information to the user interface software tool indicating that the user is currently viewing the city of Sacramento and adjacent cities displayed on the map portion 502 as shown in FIG. 5. The portion of the GUI 500 can also include fields 512 for displaying additional search criteria 514 and GIS layer selection data 516.

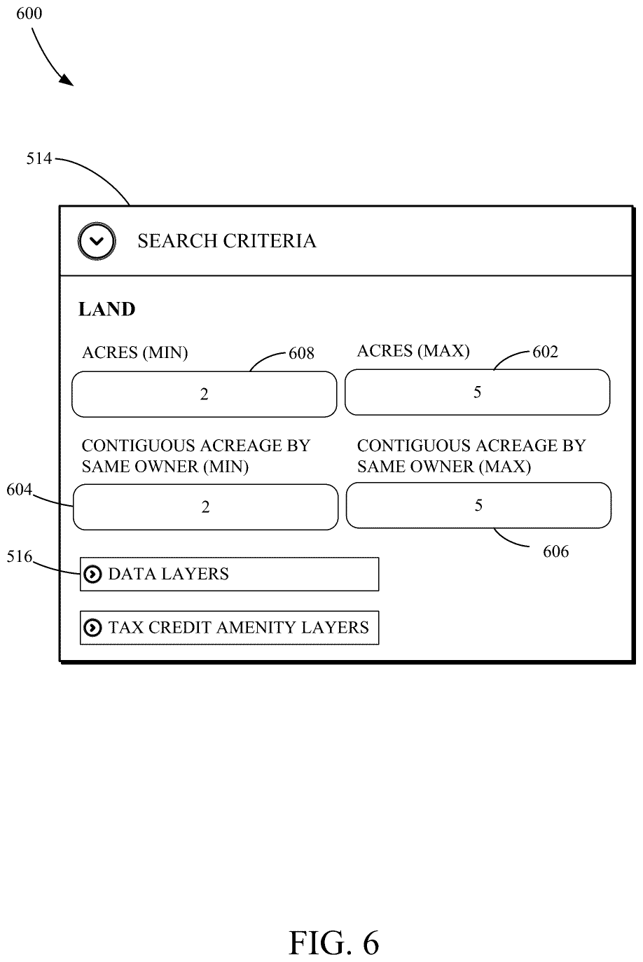

FIG. 6 is an example of a portion of a GUI 600 illustrating the fields for displaying additional search criteria 514 and GIS layer selection data 516 at a GUI of a client of a system for automated discovery of real properties using GIS data sources. The additional search criteria 514 includes inputs for receiving a minimum parcel size 608, a maximum parcel size 602, a minimum contiguous parcel size 604, and a maximum contiguous parcel size 606. A user may input the desired search criteria in these fields and the client can send data representing the search criteria to the system for discovering parcels.

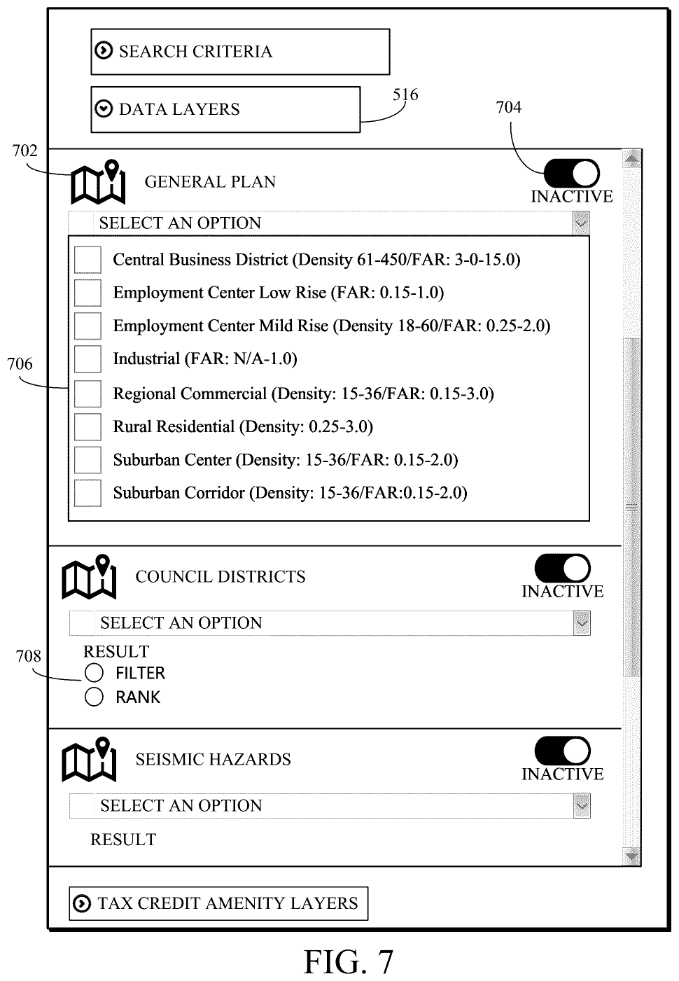

FIG. 7 is an example of a portion of a GUI illustrating the fields for displaying GIS layer selection data 516 at a GUI of a client of a system for automated discovery of real properties using GIS data sources. The GIS layer selection data 516 includes a description of each GIS data layer 702, a toggle 704 for selecting whether a GIS data layer is active, checkboxes 706 for selecting options for the GIS data layer, and a selector 708 for selecting whether to filter using the criteria or rank the results using the criteria.

In instance where the selector 708 indicates to filter using the criteria, the criteria is considered a hard criterion, and the dataset is fused using an intersection operation. In instances wherein the selector 708 indicates to rank the results using the criteria, the criteria are considered a soft criterion and the dataset is fused using a union operation.

In the example of FIG. 7, the GIS layer selection data includes a general plan portion, a council district portion, and a seismic hazard portion. Other GIS layers may be viewed by scrolling the downward and implementations are not limited to the GIS layers shown in FIG. 7.

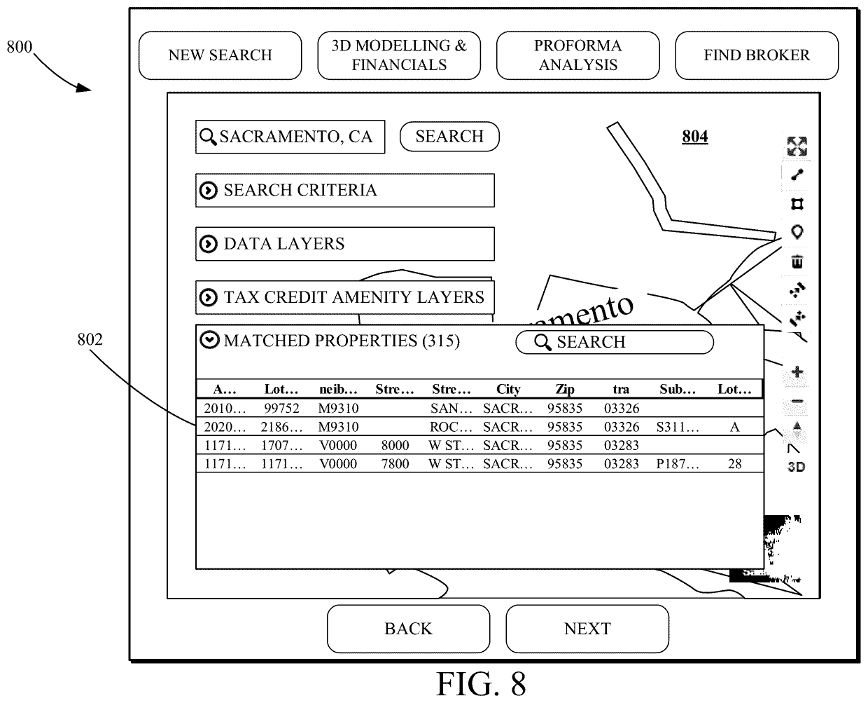

FIG. 8 is an example of a portion of a GUI 800 illustrating a return of results data 802 at a client of system for automated discovery of parcels using GIS data sources. The results data 802 includes a listing of parcels that match the search criteria entered by the user as generated by a fuse operation described previously. Additionally, a map portion 804 in the background can include icons representing the geographical location of each of the parcels. The results data can display information about the parcels such as the parcel number, the address, and the neighborhood. A user can select properties to for a display of further information by clicking or otherwise highlighting the parcel.

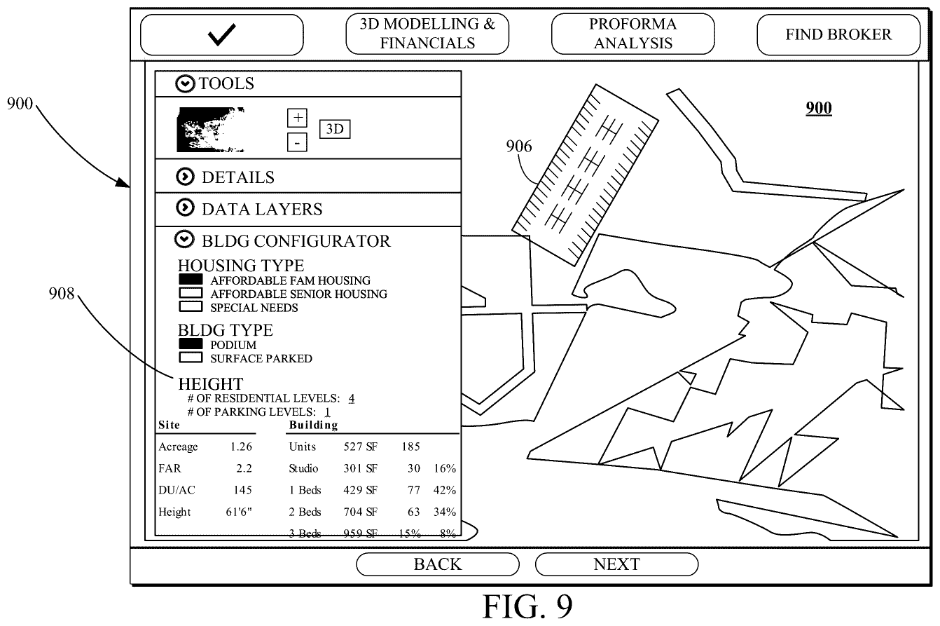

FIG. 9 is an example of a portion of a GUI illustrating a detailed view of a parcel for a client of a system for automated discovery of parcels using GIS data sources. For instance, the view of FIG. 9 may be displayed after a user selects a parcel in the portion of the GUI displayed in FIG. 8. A map portion 904 of the GUI is zoomed into the selected parcel 906 and a building configurator field 908 allows a user to input information about a development project for the selected parcel. The system can generate a basic design for the parcel based on the user input information in the building configuration field 908 and can include information such as the number of units that may be built on the parcel given the user inputs in the building configuration field.

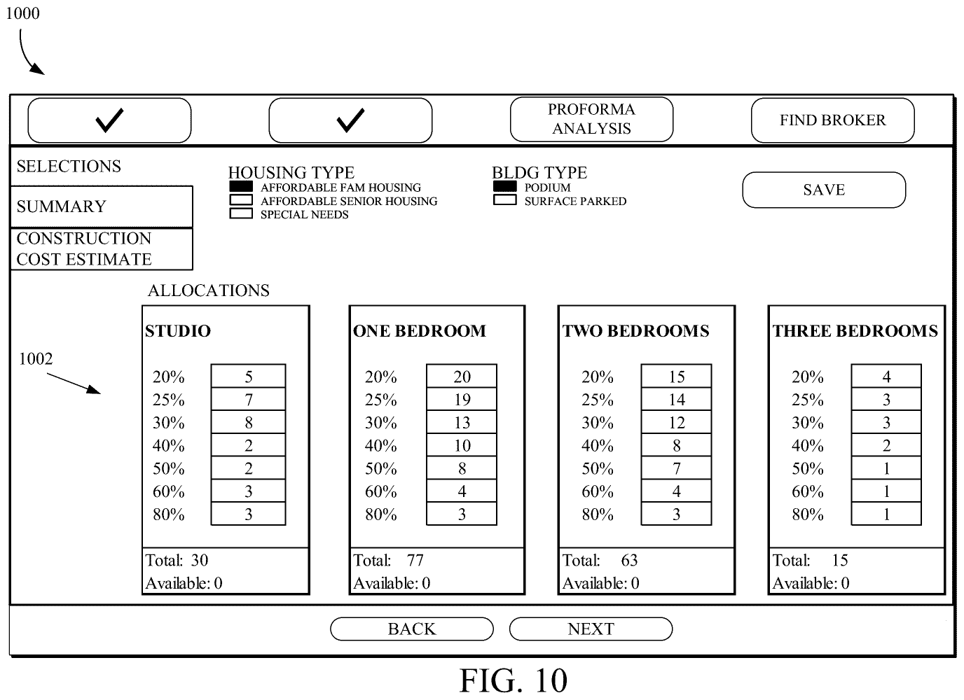

FIG. 10 is an example of a portion of a GUI 1000 illustrating an interface for entering project parameters at a client of a system for automated discovery of real properties using GIS data sources. The information displayed in FIG. 10 may be carried over from the information input in the building configuration field 908 of FIG. 9. Additionally, the portion of the GUI in FIG. 10 allows a user to adjust the allocation of units in the development project to visualize how the mix of units affects the value projections for the project.

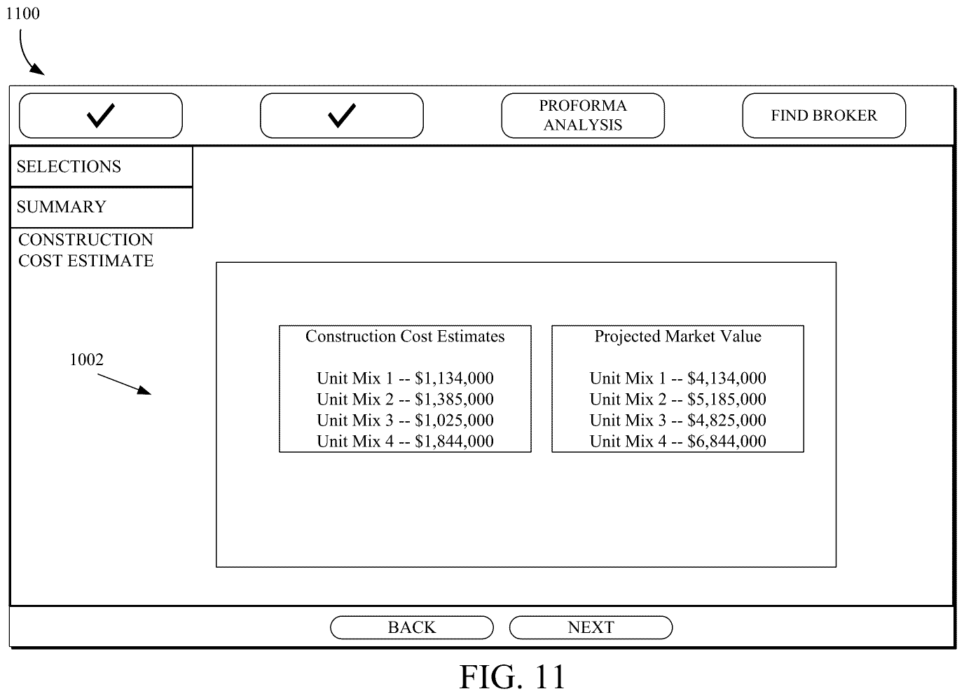

FIG. 11 is an example of a portion of a GUI 1100 illustrating an interface for outputting value information 1102 for a client of a system for automated discovery of real properties using GIS data sources. The value information 1102 can include value information generated by a value model such as the value model of FIG. 3. Additionally, the value data can include value data for the planned project and value data for variations of the planned project. In the example of FIG. 11, the value information includes construction cost estimates and a projected market value for the development. However, in other examples other value data may be displayed.

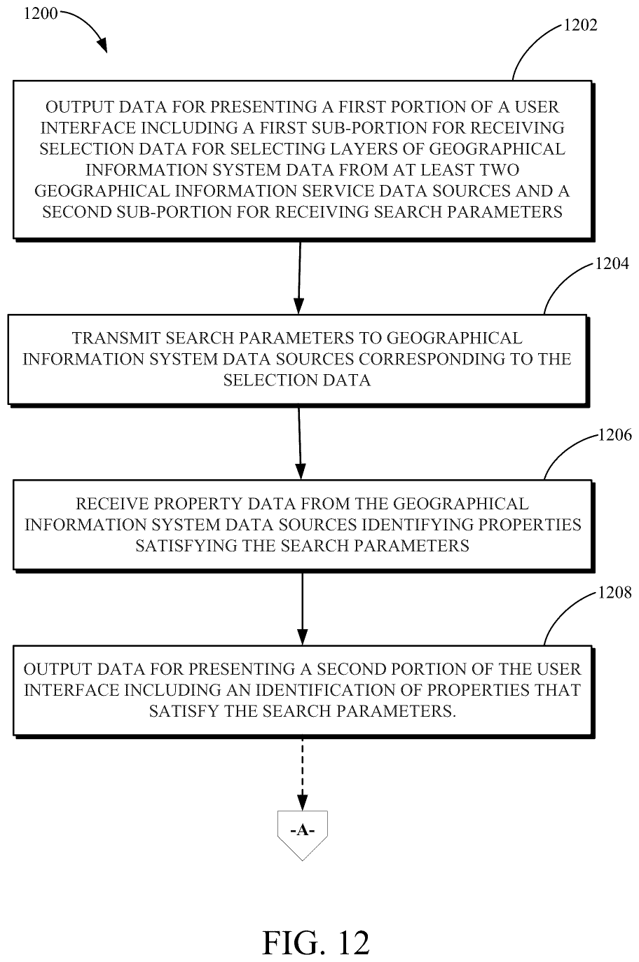

To further describe some implementations in greater detail, reference is next made to examples of techniques which may be performed by or using a system for automated discovery of parcels using GIS data sources. FIG. 12 is a flowchart of an example of a technique 1200 for automated discovery of parcels. The technique 1200 can be executed using computing devices, such as the systems, hardware, and software described with respect to FIGS. 1-11. The technique 1200 can be performed, for example, by executing a machine-readable program or other computer-executable instructions, such as routines, instructions, programs, or other code. The steps, or operations, of the 1200 or another technique, method, process, or algorithm described in connection with the implementations disclosed herein can be implemented directly in hardware, firmware, software executed by hardware, circuitry, or a combination thereof.

For simplicity of explanation, the technique 1200 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter. In the technique, at 1202 data is output for presenting a first portion of a user interface including a first sub-portion for receiving selection data for selecting layers of geographical information system data from at least two geographical information service data sources and a second sub-portion for receiving search criteria, at 1204 search criteria are transmitted to geographical information system data sources corresponding to the selection data, at 1206 parcel data is received from the geographical information system data sources identifying properties satisfying the search criteria, and at 1208 data is output for presenting a second portion of the user interface including an identification of properties that satisfy the search criteria.

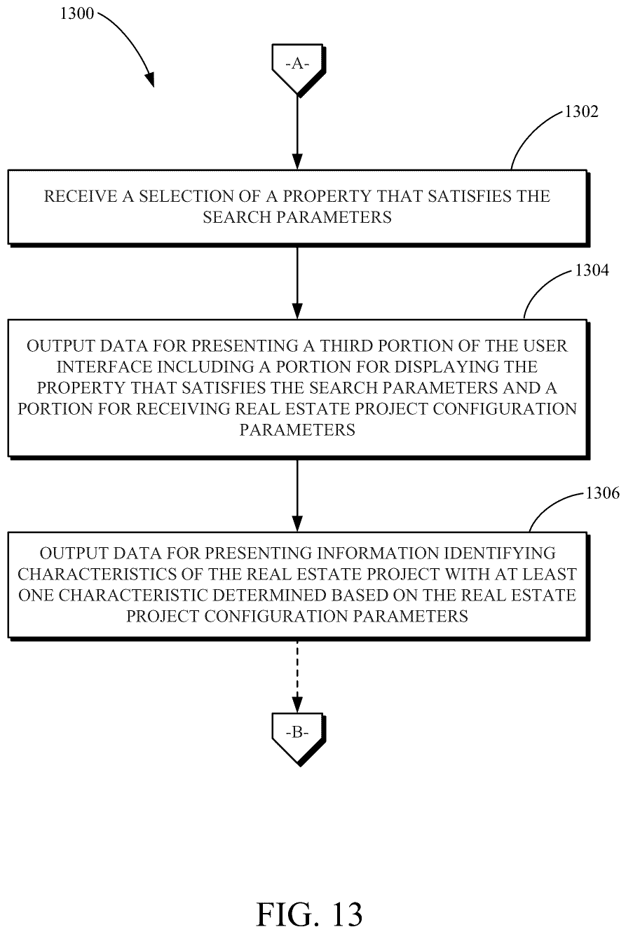

Optionally, the technique can continue to include the elements depicted in the flowchart of FIG. 13 as indicated by the dashed line leading to connector-A-which is continued in FIG. 13. The technique shown in FIG. 13 can include the steps illustrated in FIG. 12, but further includes, at 1302, receiving a selection of a parcel that satisfies the search criteria, at 1304, outputting data for presenting a third portion of the user interface including a portion for displaying the parcel that satisfies the search criteria and a portion for receiving project configuration parameters, and, at 1306, outputting data for presenting information identifying characteristics of the project with at least one characteristic determined based on the project configuration parameters.

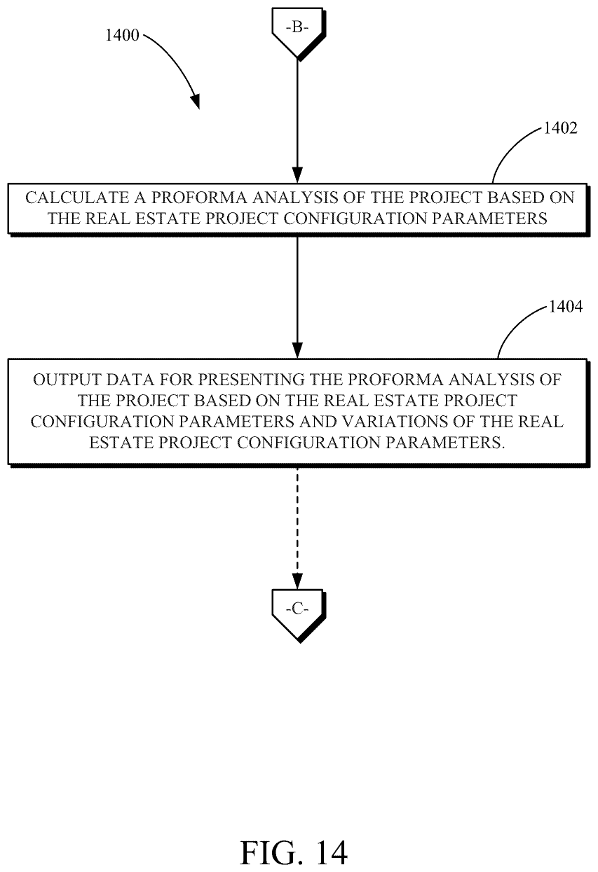

Optionally, the technique described in FIG. 13 can further include the elements depicted in the flowchart of FIG. 14 as indicated by the dashed line leading to connector-B-which is continued in FIG. 14. The technique shown in FIG. 14 can include the steps illustrated in FIG. 13, but further includes, at 1402, calculating a proforma analysis of the project based on the project configuration parameters, and at 1404, outputting data for presenting the proforma analysis of the project based on the project configuration parameters and variations of the project configuration parameters.

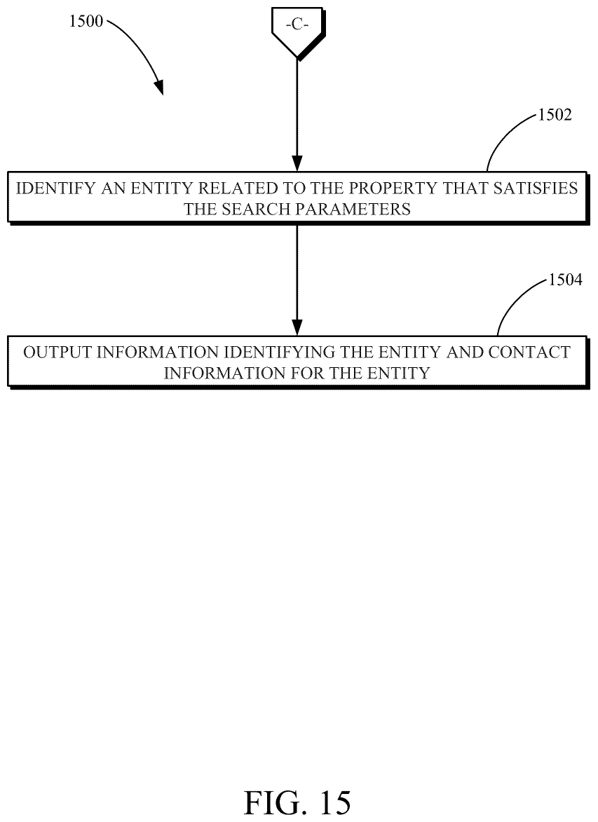

Optionally, the technique described in FIG. 14 can further include the elements depicted in the flowchart of FIG. 15 as indicated by the dashed line leading to connector-A-which is continued in FIG. 15. The technique shown in FIG. 15 can include the steps illustrated in FIG. 14 but further includes at 1402, identifying an entity related to the parcel that satisfies the search criteria and at 1404, outputting information identifying the entity and contact information for the entity.

The described steps can be performed recursively to evaluate multiple parcels. Additionally, in some implementations, some of the steps may be performed in parallel to enable a developer to evaluate multiple parcels at a time.

The implementations of this disclosure correspond to methods, non-transitory computer readable media, apparatuses, systems, devices, and the like. In some implementations, a method comprises outputting data for displaying a first portion of a user interface, wherein the first portion of the user interface includes a first sub-portion for receiving selection data for selecting layers of geographical information system data from at least two geographical information service data sources of the multiple geographic information system data sources and a second sub-portion for receiving search criteria, wherein at least one search criteria of the search criteria is related to the at least two geographical information system data; transmitting search criteria to a subset of the geographical information system data sources corresponding to the selection data; receiving parcel data from the subset of the geographical information system data sources identifying properties satisfying the search criteria; and outputting data for displaying a second portion of the user interface, wherein the second portion of the user interface includes an identification of properties that satisfy the search criteria. In some implementations, a system comprises a server component including a processor, memory, and a communication interface, wherein the communication interface enables communication between a client device and the server component and between multiple geographic information system data sources, wherein the memory stores instructions executable by the processor to output data for displaying a first portion of a user interface, wherein the first portion of the user interface includes a first sub-portion for receiving selection data for selecting layers of geographical information system data from at least two geographical information service data sources of the multiple geographic information system data sources and a second sub-portion for receiving search criteria, wherein at least one search criteria of the search criteria is related to the at least two geographical information system data; transmit search criteria to a subset of the geographical information system data sources corresponding to the selection data; receive parcel data from the subset of the geographical information system data sources identifying properties satisfying the search criteria; and output data for displaying a second portion of the user interface, wherein the second portion of the user interface includes an identification of properties that satisfy the search criteria. In some implementations, a non-transitory computer readable medium stores instructions operable to cause one or more processors to perform operations comprising outputting data for displaying a first portion of a user interface, wherein the first portion of the user interface includes a first sub-portion for receiving selection data for selecting layers of geographical information system data from at least two geographical information service data sources of the multiple geographic information system data sources and a second sub-portion for receiving search criteria, wherein at least one search criteria of the search criteria is related to the at least two geographical information system data; transmitting search criteria to a subset of the geographical information system data sources corresponding to the selection data; receiving parcel data from the subset of the geographical information system data sources identifying properties satisfying the search criteria; and outputting data for displaying a second portion of the user interface, wherein the second portion of the user interface includes an identification of properties that satisfy the search criteria.

In some implementations of the method, non-transitory computer readable medium, or apparatus, the method comprises, the systems operations comprise, or the processor is configured to execute the instructions for ranking the properties that satisfy the search criteria; and displaying the identification of properties that satisfy the search criteria in a ranked order.

In some implementations of the method, non-transitory computer readable medium, or apparatus, the method comprises, the systems operations comprise, or the processor is configured to execute the instructions for receiving a selection of a real estate parcel that satisfies the search criteria; outputting data for displaying a third portion of the user interface, wherein the third portion of the user interface includes a portion for displaying the real estate parcel that satisfies the search criteria and a portion for receiving real estate project configuration parameters; and outputting data for displaying information identifying characteristics of the real estate project with at least one characteristic determined based on the real estate project configuration parameters.

In some implementations of the method, non-transitory computer readable medium, or apparatus, the method comprises, the systems operations comprise, or the processor is configured to execute the instructions to calculate a proforma analysis of the project based on the real estate project configuration parameters; and output data for displaying the proforma analysis of the project based on the real estate project configuration parameters and variations of the real estate project configuration parameters.

In some implementations of the method, non-transitory computer readable medium, or apparatus, the method comprises, the systems operations comprise, or the processor is configured to execute the instructions to identify an entity related to the real estate parcel that satisfies the search criteria; and output information identifying the entity and contact information for the entity.

In some implementations of the method, non-transitory computer readable medium, or apparatus, the method comprises, the systems operations comprise, or the processor is configured to execute the instructions to receive user data for generating a pro forma analysis of a project, wherein the pro forma analysis of the project is based on the user data.

In some implementations of the method, non-transitory computer readable medium, or apparatus, the at least two geographical information service data sources comprise a zoning data source, a city general plan data source, a hazard data source, a tax credit data source, a demographic data source, or a transportation plan data source.

In some implementations of the method, non-transitory computer readable medium, or apparatus, at least one search criteria are weighted, and the properties are ranked in dependence on the weight of the search criteria.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc.

Likewise, the terms “system” or “mechanism” as used herein and in the figures, but in any event based on their context, may be understood as corresponding to a functional unit implemented using software, hardware (e.g., an integrated circuit, such as an application specific integrated circuit (ASIC)), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device.

Other suitable mediums are also available. Such computer-usable or computer-readable media referred to as non-transitory memory or media and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. A system, comprising:
a server component including a processor, memory, and a communication interface, wherein the communication interface enables communication between a client device and the server component and between multiple geographic information system data sources, wherein the memory stores instructions executable by the processor to:
output data for displaying a first portion of a user interface, wherein the first portion of the user interface includes a first sub-portion for receiving selection data for selecting layers of geographical information system data from at least two geographical information service data sources of the multiple geographic information system data sources and a second sub-portion for receiving search criteria, wherein at least one search criteria of the search criteria is related to the at least two geographical information system data sources;
transmit the search criteria to a subset of the geographical information system data sources corresponding to the selection data;
receive parcel data from the subset of the geographical information system data sources identifying properties satisfying the search criteria; and
output data for displaying a second portion of the user interface, wherein the second portion of the user interface includes an identification of the properties that satisfy the search criteria.

2. The system of claim 1, wherein the memory further stores instructions executable by the processor to:
rank the properties that satisfy the search criteria; and
display the identification of properties that satisfy the search criteria in a ranked order.

3. The system of claim 1, wherein the memory further stores instructions executable by the processor to:
receive a selection of a parcel that satisfies the search criteria;
output data for displaying a third portion of the user interface, wherein the third portion of the user interface includes a portion for displaying the parcel that satisfies the search criteria and a portion for receiving project configuration parameters for a project; and
output data for displaying information identifying characteristics of the project with at least one characteristic determined based on the project configuration parameters.

4. The system of claim 3, wherein the memory further stores instructions executable by the processor to:
calculate a proforma analysis of the project based on the project configuration parameters; and
output data for displaying the proforma analysis of the project based on the project configuration parameters and variations of the project configuration parameters.

5. The system of claim 4, wherein the memory further stores instructions executable by the processor to:
identify an entity related to the parcel that satisfies the search criteria; and
output information identifying the entity and contact information for the entity.

6. The system of claim 4, wherein the memory further stores instructions executable by the processor to:
receive user data for generating a pro forma analysis of a project, wherein the pro forma analysis of the project is based on the user data.

7. The system of claim 1, wherein the at least two geographical information service data sources comprise a zoning data source, a city general plan data source, a hazard data source, a tax credit data source, a demographic data source, or a transportation plan data source.

8. The system of claim 2, wherein each search criteria are weighted, and the properties are ranked in dependence on the weight of the search criteria.

9. A method for automated discovery of parcels using multiple geographic information system data sources, comprising:
outputting data for displaying a first portion of a user interface, wherein the first portion of the user interface includes a first sub-portion for receiving selection data for selecting layers of geographical information system data from at least two geographical information service data sources of the multiple geographic information system data sources and a second sub-portion for receiving search criteria, wherein at least one search criteria of the search criteria is related to the at least two geographical information system data sources;
transmitting search criteria to a subset of the geographical information system data sources corresponding to the selection data;
receiving parcel data from the subset of the geographical information system data sources identifying properties satisfying the search criteria; and
outputting data for displaying a second portion of the user interface, wherein the second portion of the user interface includes an identification of properties that satisfy the search criteria.

10. The method of claim 9, further comprising:
ranking the properties that satisfy the search criteria; and
displaying the identification of properties that satisfy the search criteria in a ranked order.

11. The method of claim 9, further comprising:
receiving a selection of a parcel that satisfies the search criteria;
outputting data for displaying a third portion of the user interface, wherein the third portion of the user interface includes a portion for displaying the parcel that satisfies the search criteria and a portion for receiving project configuration parameters for a project; and
outputting data for displaying information identifying characteristics of the project with at least one characteristic determined based on the project configuration parameters.

12. The method of claim 11, further comprising:
calculating a proforma analysis of the project based on the project configuration parameters; and
outputting data for displaying the proforma analysis of the project based on the project configuration parameters and variations of the project configuration parameters.

13. The method of claim 12, further comprising:
identifying an entity related to the parcel that satisfies the search criteria; and
outputting information identifying the entity and contact information for the entity.

14. The method of claim 12, further comprising:
receiving user data for generating a pro forma analysis of a project, wherein the pro forma analysis of the project is based on the user data.

15. The method of claim 9, wherein the at least two geographical information service data sources comprise a zoning data source, a city general plan data source, a hazard data source, a tax credit data source, a demographic data source, or a transportation plan data source.

16. The method of claim 10, wherein each search criteria are weighted, the method further comprising:
ranking the properties in dependence on the weight of the search criteria.

17. A system, comprising:
a server component including a processor, memory, and a communication interface, wherein the communication interface enables communication between a client device and the server component and between multiple geographic information system data sources, wherein the memory stores instructions executable by the processor to:
output data for displaying a first portion of a user interface, wherein the first portion of the user interface includes a first sub-portion for receiving selection data for selecting layers of geographical information system data from at least two geographical information service data sources of the multiple geographic information system data sources and a second sub-portion for receiving search criteria, wherein at least one search criteria of the search criteria is related to the at least two geographical information system data sources;
convert the search criteria into search queries compatible with at least one of the geographic information system data sources;
transmit the search queries to a subset of the geographical information system data sources corresponding to the selection data;
receive parcel data from the subset of the geographical information system data sources identifying properties satisfying the search query; and
output data for displaying a second portion of the user interface, wherein the second portion of the user interface includes an identification of the properties that satisfy the search criteria.

18. The system of claim 17, wherein the memory further stores instructions executable by the processor to:
rank the properties based on their fit with the search criteria; and
display the identification of properties that satisfy the search criteria in a ranked order.

19. The system of claim 17, wherein the at least two geographical information service data sources comprise a zoning data source, a city general plan data source, a hazard data source, a tax credit data source, a demographic data source, or a transportation plan data source.

20. The system of claim 18, wherein each search criteria are weighted, and the properties are ranked in dependence on the weight of the search criteria.
